(19) United States
(12) Patent Application Publication
(10) Pub. No.: US 2006/0108801 A1
(43) Pub. Date: May 25, 2006

(54) Tube coupling with internal collet

(76) Inventor: Gregory E. Grosch, Laguna Beach, CA (US)

Correspondence Address: ROBERT D. FISH;RUTAN & TUCKER LLP, 611 ANTON BLVD 14TH FLOOR, COSTA MESA, CA, 92626-1931, US

(21) Appl. No.: 10/976,542

(22) Filed: Oct. 29, 2004

(51) Int. Cl. F16L 37/00

(52) U.S. Cl. 285/307

(57) ABSTRACT

A pipe fitting comprises a body and a collet slidably disposed completely within the body. Disposing the collet completely within the body mitigates the likelihood of the collet being inadvertently pushed in so as to loosen or disconnect a pipe from the pipe fitting. Optionally, a tool could be used to push the collet in so as to release the pipe from the pipe fitting. A locking clip having a break-off locking tab may alternatively be used to prevent inadvertent loosening of the tubing from the fitting. Markings or color coding could be used to insure that a correct length of tubing is inserted into a fitting. Tubing could be tapered or an expander could be used to mitigate the likelihood of damage to the fittings o-ring during insertion of tubing.

### FIELD OF THE INVENTION

The field of the invention is pipe fittings.

### BACKGROUND OF THE INVENTION

Push-in type pipe fittings are well known. Push-in type pipe fittings facilitate easy installation, removal and replacement of pipe, as well as items attached to pipe such as water tanks, faucets, spigots, pressure reducers, pressure regulators, bathtubs, showers, sinks and the like. Indeed, such pipe fittings could be used in various commercial applications, including water purification and treatments systems, beverage distribution systems, industrial pneumatics, and chemical processing systems.

Contemporary push-in type fittings comprise a collet that grabs and holds the end of a pipe so as to attach the pipe to the fitting. Generally, attaching the pipe to a fitting likewise attaches the pipe to an item such as another pipe, a water tank, a faucet, a spigot, a pressure reducer, a pressure regulator, a bathtub, a shower, a sink or the like.

According to well known principles, collets have fingers that are urged inwardly to grasp the pipe as the pipe (and consequently the collet) is pulled outwardly, away from the fitting,. Thus, pulling the pipe outwardly tends to cause the collet to hold the pipe more firmly within the fitting.

Pipe can easily be removed from such push-in type pipe fittings by simply pushing the collet inwardly, toward the fitting, so as to release the grip of the fingers thereof upon the pipe and thus allow the pipe to be withdrawn from the fitting. A portion of the collet of all known push-in type pipe fitting extends out of the body of the pipe fitting, so as to make the collet easily assessable and thereby facilitate disconnection of the pipe from the fitting.

However, since a portion of the collet extends out of the body of the pipe fitting, the collet may inadvertently be pushed inwardly, which then causes the pipe to be undesirably loosened or disconnected from the pipe fitting. Such inadvertent inward movement of the collet may occur, for example, when a person is working nearby and accidentally bumps the pipe fitting. Vibration can also cause the collet to be inadvertently pushed inward.

The problem is that even if the pipe is only inadvertently loosened, rather than completely disconnected, undesirable leakage may result. Of course, if the pipe is completely disconnected from the pipe fitting, substantial leakage may result.

Although such contemporary push-in type pipe fittings have found widespread applications in non-home use, such as commercial, marine and recreational vehicle use, these fittings have yet to be approved for home use. One reason that such contemporary push-in type fittings have heretofore not been approved for home use is their undesirable susceptibility to inadvertent loosing and disconnection, as described above. It can therefore be readily appreciated that if a pressurized water fitting leaks in a home, costly damage is likely to result.

Attempts to mitigate the likelihood of such undesirable loosening or disconnection of a push-in type pipe fitting involve the use of a circlip or half moon retainer ring, which is snapped in placed behind the collet so as to prevent the collet from being pushed inwardly until the circlip is removed. However, it is important to appreciate that the circlip could be inadvertently removed from the collet, so as to allow the collet to move inward. This is particularly true if the circlip has a tab or handle formed thereon to facilitate easy removal from the collet.

In view of the foregoing, it is desirable to provide a push-in type pipe fitting wherein the collet is protected such that it cannot be inadvertently pushed inwardly so as to undesirably allow a pipe to be loosened or disconnected from the fitting.

### SUMMARY OF THE INVENTION

In accordance with the present invention, an improved push-in type pipe fitting is provided, wherein the collet thereof is protected in a manner which prevents inadvertent loosening or disconnection of a pipe therefrom.

According to a first embodiment, the present invention comprises a pipe fitting system comprising a body and a collet slidably disposed completely within the body. The body and the collet cooperate to at least partially define a push-in type pipe fitting.

Preferably, the body comprises a main body and a cap. The main body and cap enclose the collet, so as to prevent inadvertent contact with the collet which might result in undesirable loosening or disconnection of the pipe from the pipe fitting. Typically, the main body and the cap are formed as separate pieces which are attached to one another. Optionally, the main body and the cap could be formed integrally with respect to one another.

The cap could be either permanently affixed to the main body or removably attached thereto. The cap could be permanently attached to the main body via spin welding, adhesive bonding, or any other desired method. The cap could be removably attached to the main body via the use of threads or by any other desired means.

The body, preferably the cap thereof, comprises at least one opening through which the collet is movable. That is, the collet can be pushed inwardly by inserting a tool through the opening and pushing against the collet. Preferably, two diametrically opposed openings are formed in the cap to facilitate such movement of the collet and thereby release the pipe from the fitting. However, as those skilled in the art will appreciate, any desired number of openings could be formed at various locations within the body to facilitate movement of the collet and release of the pipe from the fitting.

Optionally, a tubular insert is formed within the body. The tubular insert is positioned such that a pipe attached to the fitting receives a portion of the tubular insert. The tubular insert preferably has at least one o-ring disposed thereon, so as to inhibit leakage between the tubular insert and the pipe.

The tubular insert may either be permanently attached or formed to the body of the pipe fitting or could be removably attached thereto. If that tubular insert is removably attached to the body of the pipe fitting, then an additional o-ring is preferably formed upon the tubular insert, so as to inhibit leakage between the tubular insert and the body of the pipe fitting.

The body and the collet are preferably formed of plastic. Alternatively, the body and the collet could be formed of metal. Examples of suitable metals include iron, steel, aluminum, copper, and brass. The body and/or the collet may alternatively be formed of various other materials, such as composite materials or epoxies.

According to one aspect, the present invention comprises a tool having at least one finger formed thereon for effecting release of the pipe from the pipe fitting. The fingers are sized to fit within the openings of the body and have sufficient length to facilitate movement of the collet so as to release a pipe inserted into the fitting.

The tool preferably comprises a body which is curved so as to wrap at least partially around a tube and so as to slide thereon. Thus, the tool could be shaped such that it snaps over a pipe which is connected to the pipe fitting and slides along the pipe until the fingers thereof enter the openings formed in the body of the pipe fitting. Pushing the tool further toward the pipe fitting causes the collet to move inwardly and thus release the pipe from the pipe fitting.

According to a second embodiment of the present invention, the collet locks into one or more detents or resilient clips which are preferably disposed about a depression formed in the cap. Alternatively, the resilient clips could be disposed elsewhere upon the body or upon another structure. According to this embodiment, the collet may optionally extend partially from the body of the pipe fitting. Alternatively, the collet could be completely enclosed within the body of the pipe fitting, as in the first embodiment of the present invention. In either instance, the collet is protected from undesirable inward movement by the resilient clip(s).

The second embodiment of the present invention may find particular utility in those applications subject to shock and vibration. Examples of such applications include use proximate engines, pumps, compressors and other vibrating equipment. One further example of such an application is the use of the second embodiment of the present invention in geographic regions which are subject to earthquakes.

As those skilled in the art will appreciate, shock and vibration may tend to cause the collet of a conventional push-in type pipe fitting to move inwardly and thus undesirably loosen the pipe attached thereto. The resilient clips of the second embodiment of the present invention will substantially mitigate such undesirable loosening.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a exploded perspective view of an exemplary protected push-in type pipe fitting.

FIG. 2 is an end view of the cap of FIG. 1 showing two grooves formed therein that facilitate the insertion of a tool so as to move the collet and release a pipe from the fitting.

FIG. 3 is cross-sectional side view of an exemplary T-fitting according to a first embodiment of the present invention.

FIG. 4 is a perspective view of the T-fitting of FIG. 3.

FIG. 5 is a perspective view of an exemplary tool according to the first embodiment of the present invention.

FIG. 6 is a perspective view of an alternative cap having a plurality of resilient clips formed about an opening in the end thereof so as to lock the collet in an extended position, according to a second embodiment.

FIG. 7 is an exploded view of a body insert, collet, and O-ring.

FIG. 8 is an exploded view showing the collet being preventing from moving inwardly so as to release a tube by a locking clip.

FIG. 9 is a side view of a locking clip having a break-off tab according to the present invention.

FIG. 10 is a side view of a section of tubing having markings formed thereon.

FIG. 11 is a side view of a section of tubing having color coding formed thereon.

FIG. 12 is a perspective view of a tubing tapering device showing s section of tubing about to be inserted therein.

FIG. 13 is a series of illustrations showing untapered tubing being inserted into a fitting.

FIG. 14 is a series of illustrations showing tapered tubing being inserted into a fitting.

FIG. 15 is a series of illustrations showing the use of an expander to mimic the effect of tapered tubing without having a taper formed upon the tubing.

### DETAILED DESCRIPTION

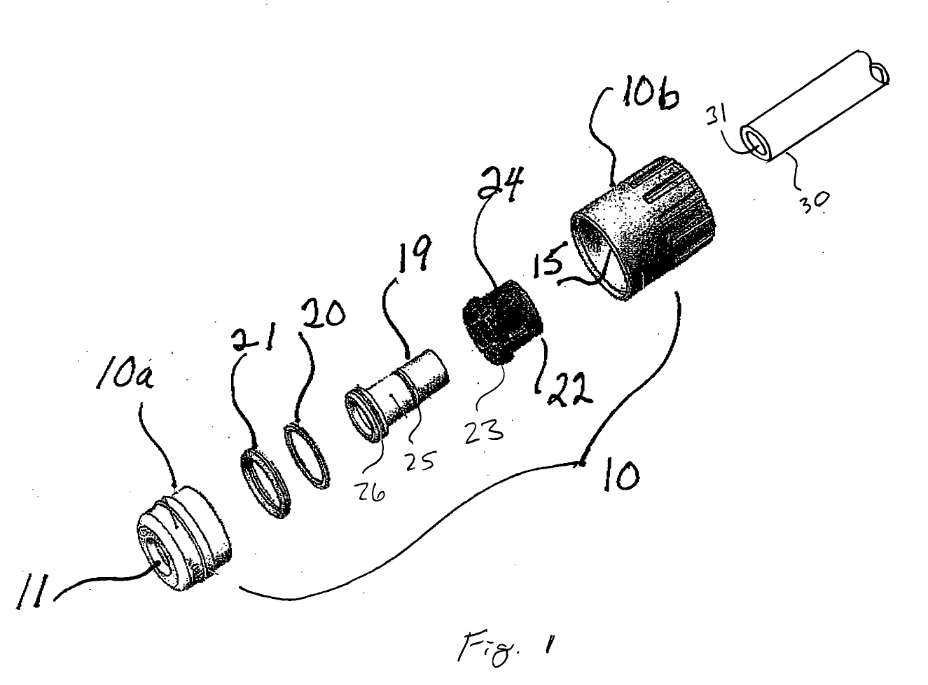

Referring now to FIG. 1, a first embodiment of the protected push-in type pipe fitting 10 generally comprises a body comprised of a main body 10a and a cap 10b. Slidably disposed within the body is a collet 24, which has a race 22 formed at one end, and a plurality of fingers 23 formed at its other end. The collet 24 slides within the body so as to grip and hold an end of a length of pipe 30 inserted into the fitting according to well-known principles.

Also contained within the body preferably are removable tubular insert 19, locking guide ring 20 and o-ring seal 21. The tubular insert 19 preferably has o-ring seal 25 formed thereon so as to inhibit leakage between itself and pipe 30. Further, the tubular insert 19 also preferably has o-ring seal 26 disposed thereon so as to inhibit leakage between itself and the main body 10a.

The tubular insert 19 may alternatively be non-removable and could be formed to the main body 10a. In this instance the o-ring 26 is not required since the proximal end of the tubular insert 19 is attached to the main body 10a such that leakage between the tubular insert 19 and the main body does not occur.

Although described herein generally as for use with pipe, those skilled in the art will appreciate that the present invention is likewise suitable for use with tubes, hoses, ribbed metal flex lines and the like. Thus, use of the word pipe is by way of example only and not by way of limitation. Indeed, as used herein, the term “pipe” is generally defined to include pipe, tubing, hose, ribbed metal flex line, and the like.

The locking guide ring 20 holds the o-ring seal 21 in place, especially during insertion and removal of the pipe 30.

The o-ring seal 21 provides a seal against the inserted end of the pipe 30 and thus inhibits leakage between the main body 10a and the pipe 30.

The collet 24 and the tubular insert 19 are received within the bore 15 of the cap 10b. Fluid flows through thruway 11 formed in the main body, which forms a generally continuous passage with the bore 31 of the pipe 30.

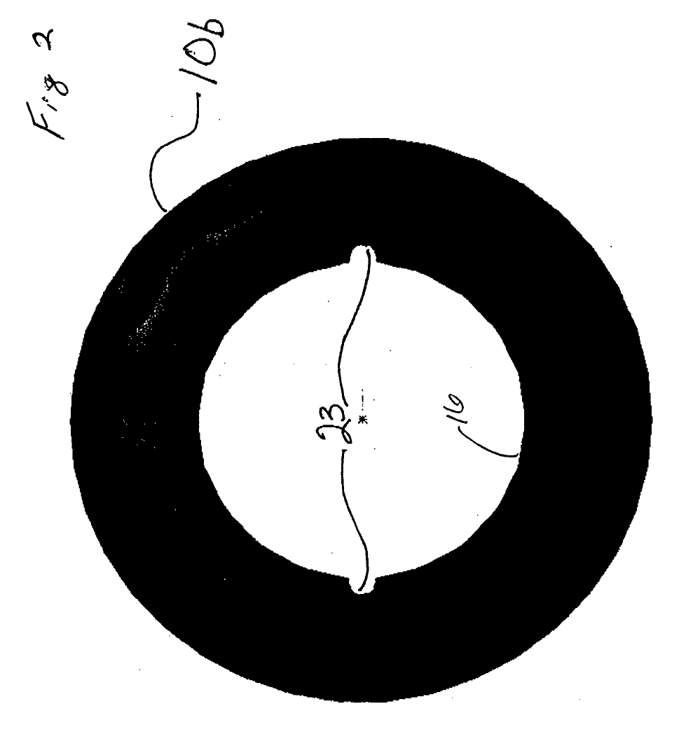

Referring now to FIG. 2, the cap 10b, preferably has two openings, voids, slots or grooves 23 formed proximate the opening 16 though which the pipe 30 is inserted into the pipe fitting 10. A tool comprising elongated fingers or the like could be inserted through the grooves 23 into the body of the pipe fitting so as to push the collet 24 inwardly and thereby cause the collet 24 to release its grip upon the pipe 30, so that the pipe 30 could be removed from the pipe fitting. One example of such a tool is described in detail below.

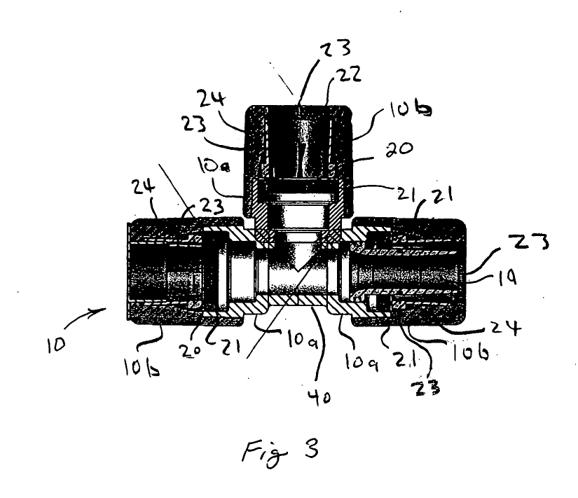

Referring now to FIGS. 3 and 4, three of the pipe fittings shown in FIG. 1 could be assembled upon T-fitting body 40 so as to define a single T-fitting. Such a T-fitting is one example of an application of the protected push-in type pipe fitting of the present invention. As those skilled in the art will appreciate, many other examples of such applications exist. The protected push-in type pipe fitting of the present invention may similarly be used to attach a pipe to another pipe (of either the same or a different diameter), to attach a pipe to a variety of different types of fittings, and to attach a pipe to a variety of different devices or appliances.

With particular reference to FIG. 4, the grooves 23 are formed along a periphery of the opening 16 through which the pipe 30 is inserted into the fitting. Alternatively, holes 43 could be formed in the cap 10b to similarly facilitate movement of the collet 24 inwardly to release the pipe 30. Thus, one or more holes, grooves, or the like are preferably formed in the body, preferably in the cap 10b thereof, so as to facilitate inward movement of the collet, such as with a tool as described in detail below.

Alternatively, no such holes, grooves, or the like are provided, so as to define a permanent fitting wherein the pipe 30 cannot be remove therefrom without substantial damage to the fitting and/or the pipe 30.

In use, the pipe 30 is inserted into the body of the pipe fitting as far as it will go. Then, the pipe 30 is pulled outwardly, away from the pipe fitting so as to cause the collet 24 to likewise move outwardly. When the collet 24 moves outwardly, the fingers 23 thereof are cammed radially inward by a camming surface which is typically formed on the inside of the body, so as to grasp and hold the end of the pipe 30 according to well known principles.

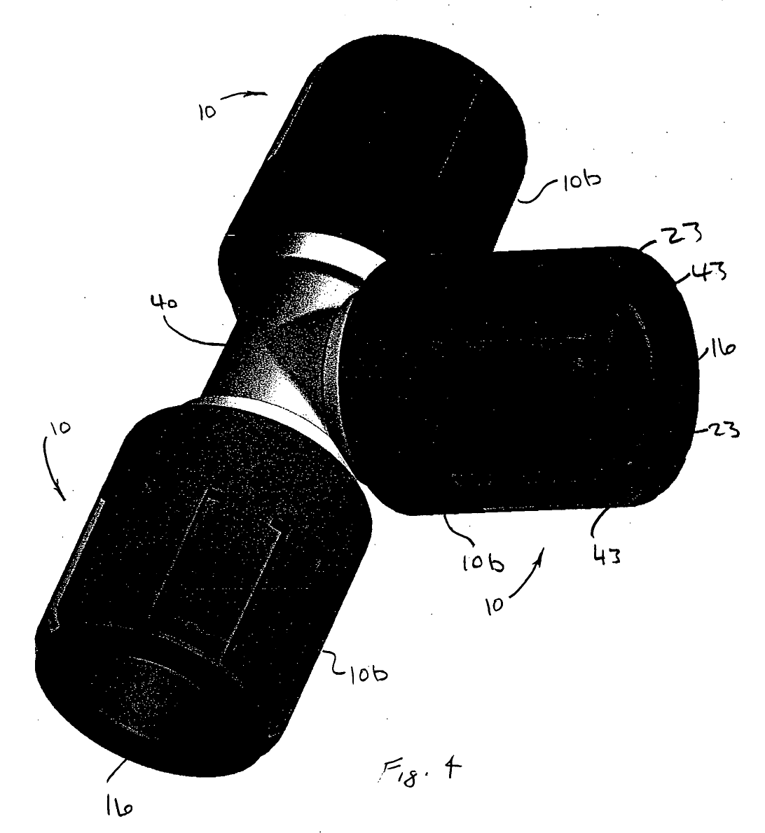

Referring now to FIG. 5, a tool may optionally be used for pushing the collet 24 inwardly so as to release the grip of the collet 24 upon the pipe 30 and thus allow the pipe 30 to be easily removed from the pipe fitting. The tool preferably comprises body 50 and two fingers 51. The body 50 is preferably curved such it is complementary to and wraps around the pipe 30. Preferably, the body 50 is sized to snap upon the pipe 30 such that it captures the pipe 30 therein and remains upon the pipe 30 until snapped therefrom.

The fingers 41 extend sufficiently from the body 50 of the tool so as to move the collet 24 inwardly and thus release the pipe 30 from the pipe fitting 10 when the tool is placed around the pipe 30 and pushed toward the pipe fitting 10.

Alternatively, the grooves 23, holes 43, or other openings in the body of the pipe fitting 10 could be formed such that an ice pick, awe, small screwdriver, or other tool could be inserted therethrough to effect inward movement of the collet 24.

Optionally, a visual indication that the collet has be moved to its pipe grasping outermost position could be provided. For example, a protrusion such as a tab or rod could be formed to the collet such that the protrusion extends through an opening in the cap to indicate the position of the collet. Alternatively, a window could be formed in the body to provide such a visual indication of the position of the collet.

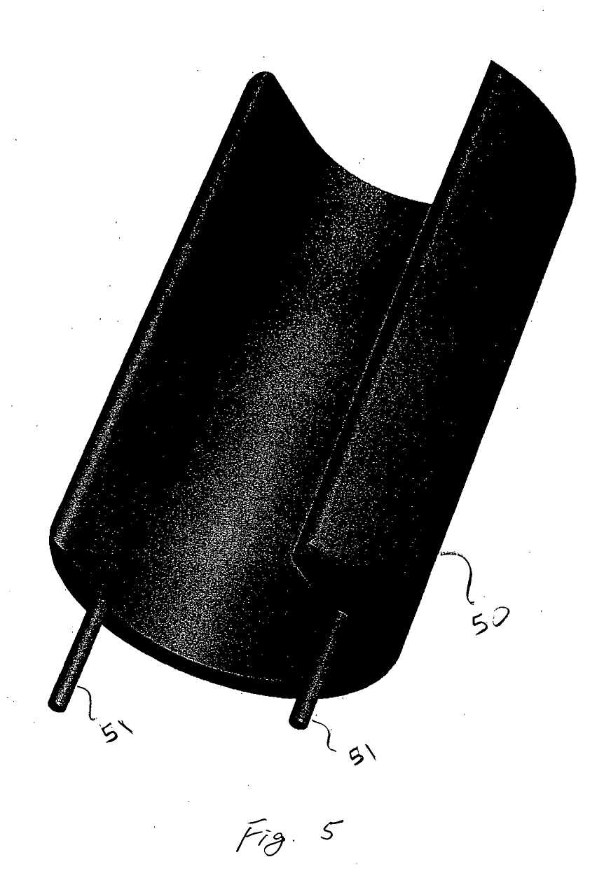

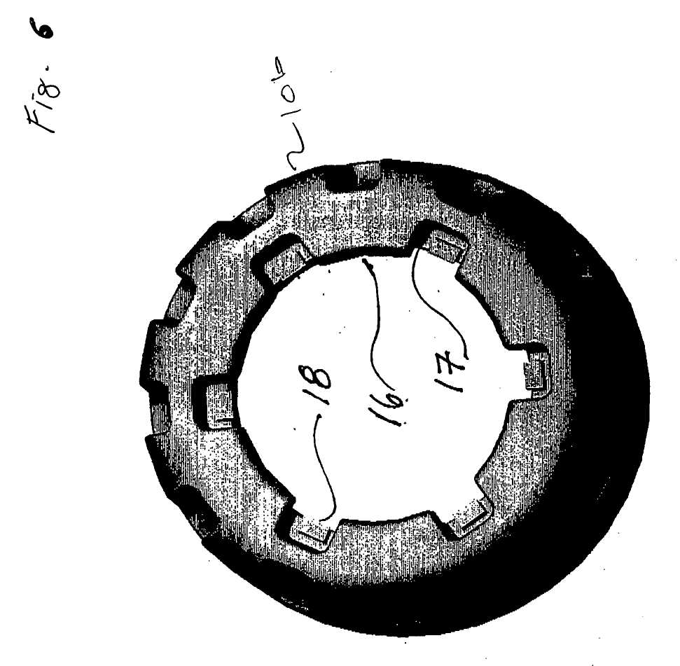

Referring now to FIG. 6, according to a second embodiment of the present invention, the cap 10b has an opening 16 formed therein so as to snuggly receive the pipe 30 and thus inhibit inadvertent radial movement thereof. Spaced about the opening 16 are a plurality of indentations 17 which are formed concentrically with respect to the opening 16. Resilient clips 18 formed within the indentations 17. The resilient clips extend into the opening 16 sufficiently to engage the race 22 of the collet in a manner that locks the collet 24 in place once the collet has been moved outwardly, away from the body of the fitting 10.

Thus, according to the present invention, a push-in type fitting has a collet that is protected from inadvertent release of a pipe from the fitting. The fitting is suitable for in-home use, as well for use in the more traditional applications of such fittings. By protecting the collet from inadvertent release, the likelihood of leakage is substantially mitigated.

The protected pipe fitting of the present invention could be used in various pneumatic, hydraulic, aqueous fluid and other fluid handling applications utilizing metal or plastic pipe, tubes or hoses. For example, the present invention could be used to couple polyurethane (PU), polyethylene (PE), polypropylene (PP), cross-linked polyethylene (PEX), copper, brass, and other types of pipes, tubes, and hoses. The present invention is also suitable for use with ridged pipes.

The present invention is suitable for applications including commercial, residential, marine and recreational vehicle potable water systems, commercial and residential water purification and treatment systems, beverage distributions systems, industrial pneumatics and chemical processing, as well as various other applications.

There are additional concepts that can be practiced independently of the inventive collet and pipe fittings, but which can also be used very advantageously along with or in place of such collet and fittings.

Locking Clip With Break Off Tab

A locking clip with a break-off tab 116 can be used to secure a standard type collet. Once the tab is broken off, a collet cover can be slipped over the collet to protect the collet, and prevent the clip from slipping out.

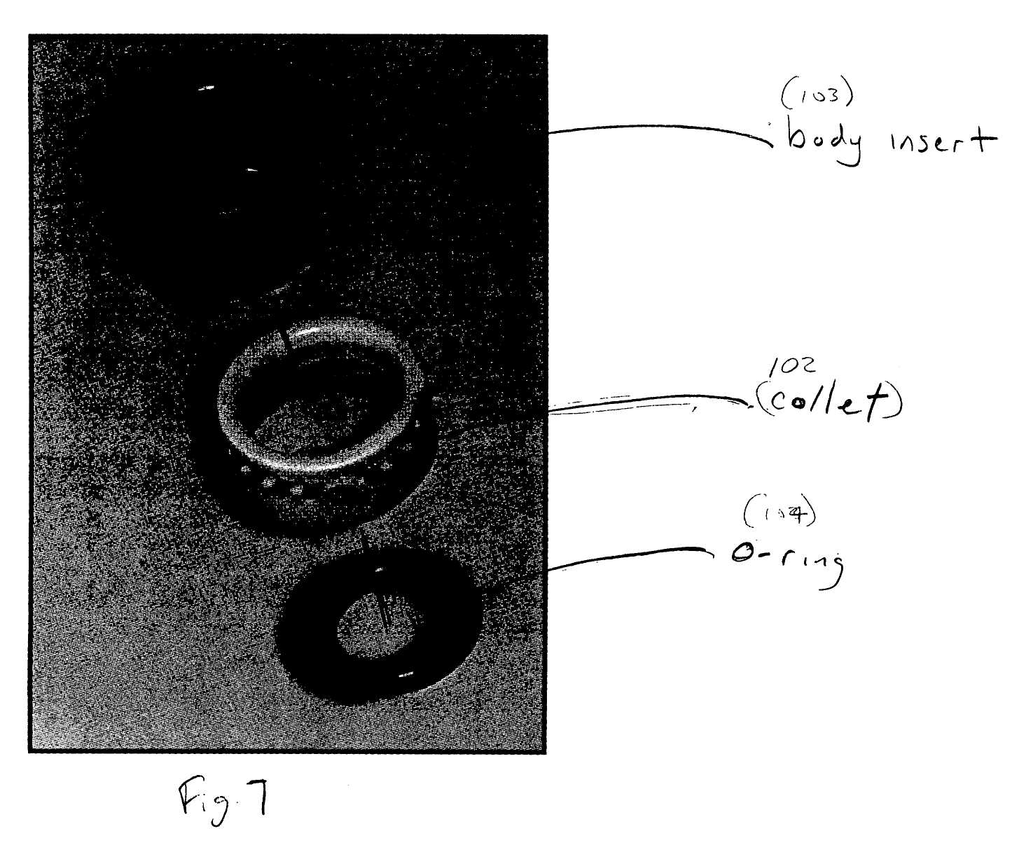

In FIGS. 7, 8, and 9 a collet cooperates with the shape of the exterior walls of a body insert 103 and a washer 104 to tighten around a tube 110 when the tube is being pulled away from a fitting 100. The lip of the collet 102 is held away from the body 100 by locking clip 115 having a tab 116. Once the tab 116 of clip 115 is broken off, the collet cover 120 can be fitted over the lip and remaining portion of the clip.

Tubing With Markings

Tubing can be provided with markings that advantageously indicate when the tubing has been inserted sufficiently into a coupling or the like so as to provide a proper seal therewith.

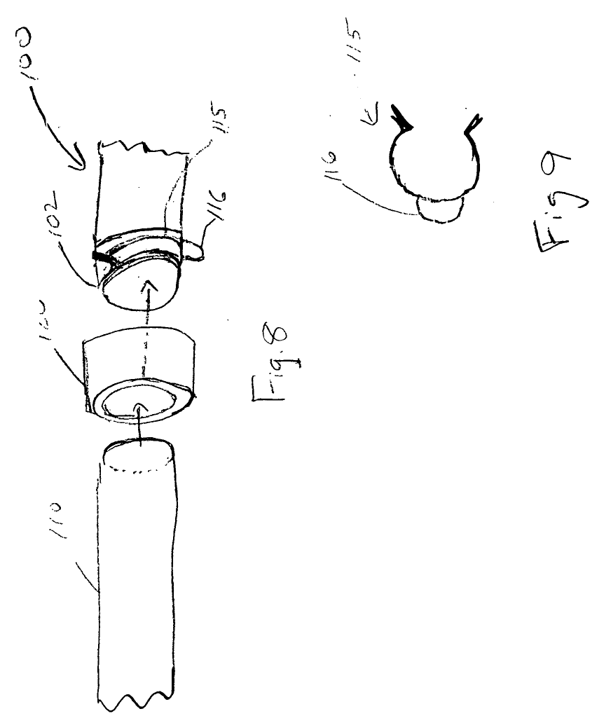

In FIG. 10 markings formed upon tubing show when a desired length thereof has been inserted into a fitting or the like. The tubing is simply cut at one marking and then the additional markings function as a scale to show how much of the tubing has been inserted.

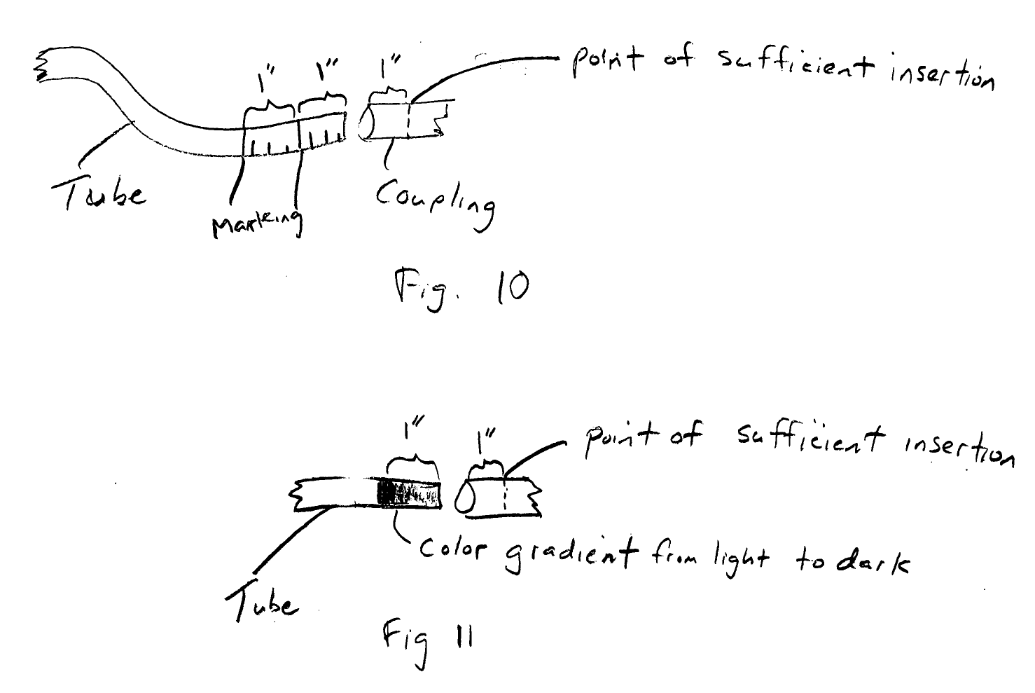

In FIG. 11 color coding may alternatively be used to indicate when a desired length of tubing has been inserted. For example, if one inch of insertion is desired, then tubing having a one inch color gradient formed thereon can be used. The tubing is cut at the beginning of the gradient. When the entire color gradient has been inserted, and no more of the colored area can be seen, the tubing has been inserted properly.

Tapered Tubing For Fluid Connectors

Tubing can be tapered to mitigate the likelihood of damage to the seal of a fitting or the like during insertion of the tubing into the fitting. Alternatively, an expander could be provided so as to mimic the effect of a taper formed upon the end of a tube without having to actually form a taper upon the tube.

In FIG. 12 a section of tubing is being inserted into a tapering device so as to form a taper thereon. The tapering device is similar to a pencil sharpener, except that it is specifically configured to receive tubing of a given size and to form a taper thereon.

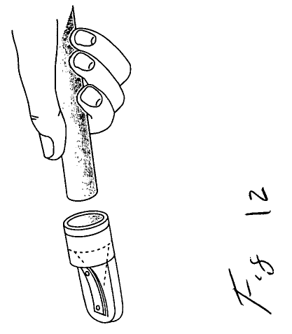

In FIG. 13 it can be seen that forcing untapered tubing into a fitting may cause damage to the o-ring thereof. Such damage may occur, for example, when the end of the tubing forces the o-ring to suddenly expand.

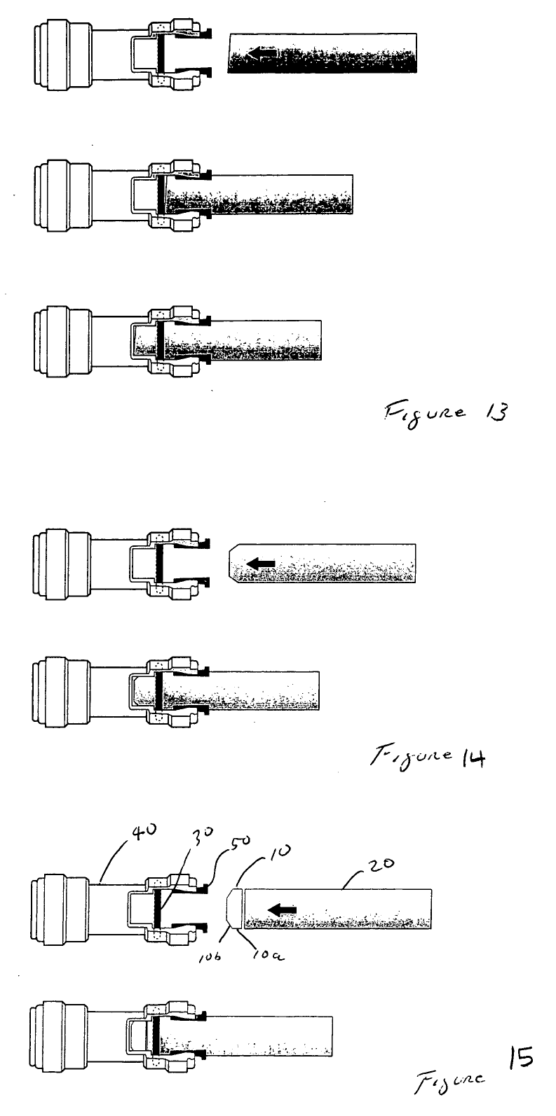

In FIG. 14 it can be seen that a taper formed upon the end of the tubing allows the o-ring to more gradually expand. Thus, tapered tubing is substantially less likely to cause damage to the o-ring.

In FIG. 15 it can be seen that a separate expander 10 may alternatively be used to provide the effect of a taper without having to actually taper the tubing 20. The expander 10 passes through the o-ring 30 and generally becomes permanently captured inside the fitting.

Thus, specific embodiments and applications of protected pipe fitting have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps could be present, or utilized, or combined with other elements, components, or steps that are not expressly referenced.

What is claimed is:

1. A pipe fitting system comprising:
a body; and
a collet slidably disposed completely within the body.

2. The pipe fitting system as recited in claim 1, wherein the body and the collet cooperate to at least partially define a push-in type pipe fitting.

3. The pipe fitting system as recited in claim 1, wherein the body comprises a main body and a cap, the main body and the cap enclosing the collet.

4. The pipe fitting system as recited in claim 1, wherein the body comprises a main body and a cap, the main body and the cap enclosing the collet, and the cap being permanently affixed to the main body.

5. The pipe fitting system as recited in claim 1, wherein the body comprises a main body and a cap, the main body and the cap enclosing the collet, and the cap being spin welded to the main body.

6. The pipe fitting system as recited in claim 1, wherein the body comprises a main body and a cap, the main body and the cap enclosing the collet, and the cap being adhesively bonded to the main body.

7. The pipe fitting system as recited in claim 1, wherein the body comprises a main body and a cap, the main body and the cap enclosing the collet, and the cap being removably attached to the main body.

8. The pipe fitting system as recited in claim 1, wherein the body comprises a main body and a cap, the main body and the cap enclosing the collet, and the cap being threaded to the main body.

9. The pipe fitting system as recited in claim 1, wherein the body comprises a main body and a cap, the collet locking to at least one resilient clip so as to inhibit inward movement of the collet.

10. The pipe fitting system as recited in claim 1, wherein the body comprises at least one opening formed therein though which the collet is movable.

11. The pipe fitting system as recited in claim 1, wherein the body comprises two openings formed therein though which the collet is movable.

12. The pipe fitting system as recited in claim 1, wherein the body comprises two diametrically opposed openings formed therein though which the collet is movable.

13. The pipe fitting system as recited in claim 1, wherein the body comprises a cap having at least one opening formed therein though which the collet is movable.

14. The pipe fitting system as recited in claim 1, wherein the body comprises a cap having two openings formed therein though which the collet is movable.

15. The pipe fitting system as recited in claim 1, wherein the body comprises a cap having two diametrically opposed openings formed therein though which the collet is movable.

16. The pipe fitting system as recited in claim 1, further comprising a tubular insert formed within the body, the tubular insert being positioned such that a pipe attached to the pipe fitting receives a portion of the insert, the tubular insert having at least one o-ring disposed thereon.

17. The pipe fitting system as recited in claim 1, further comprising a removable tubular insert disposed within the body, the tubular insert being positioned such that a pipe attached to the pipe fitting receives a portion of the tubular insert, the tubular insert having at least one o-ring disposed thereon so as to seal between the tubular insert and the pipe and having at least one o-ring formed thereon so as to seal between the tubular insert and the body.

18. The pipe fitting system as recited in claim 1, wherein at least one of the body and the collet are formed of plastic.

19. The pipe fitting system as recited in claim 1, wherein at least one of the body and the collet are formed of metal.

20. The pipe fitting system as recited in claim 1, wherein:
the body comprises at least one opening formed therein though which the collet is movable; and
further comprising a tool having at least one finger, the finger(s) being sized to fit within the opening(s) and having sufficient length so as to facilitate movement of the collet to release tubing inserted into the pipe fitting.

21. The pipe fitting system as recited in claim 1, wherein the body comprises at least one opening formed therein though which the collet is movable, and further comprising a tool having:
a body which is curved so as to wrap at least partially around a tube and so as to slide thereon; and
at least one finger, the finger(s) being sized to fit within the opening(s) and having sufficient length so as to facilitate movement of the collet to release tubing inserted into the pipe fitting.

22. A pipe fitting system comprising:
a body;
a collet slidably disposed completely within the body; and
at least one clip formed to the body so as to lock the collet in an extended position.
